(19) United States
(12) Patent Application Publication
(10) Pub. No.: US 2022/0138695 A1
(43) Pub. Date: May 5, 2022

(54) SYSTEM AND METHOD FOR FACILITATING INTERACTION BETWEEN TWO GROUPS OF USERS

(71) Applicant: Who To Work For, LLC, Eagan, MN (US)

(72) Inventor: Chad Harrington, Eagan, MN (US)

(21) Appl. No.: 17/517,617

(22) Filed: Nov. 2, 2021

Related U.S. Application Data
(60) Provisional application No. 63/108,608, filed on Nov. 2, 2020.

(51) Int. Cl. G06Q 10/10; G06Q 10/06; G06Q 30/00

(52) U.S. Cl. CPC G06Q 10/103; G06Q 30/01; G06Q 10/063114

(57) ABSTRACT

A processor-based method of facilitating interaction and records regarding a home includes initiating a home profile; prompting a contractor to provide contractor data regarding the home; receiving the contractor data; populating the home profile with the contractor data; inviting an owner of the home to accept the home profile; if the owner accepts the home profile, prompting the owner to provide owner data regarding the home; receiving the owner data; populating the home profile with the owner data; and connecting the contractor and the owner together to interact and engage through the home profile. As such, accurate historical records regarding the home are maintained and interaction between the contractor and owner provides updating of the home profile, maintenance of the home and lead generation.

### FIELD OF THE DISCLOSURE

This invention relates to a system and method for a multi-sided platform that serves as an intermediary to connect two or more mutually supporting user groups, where multiple suppliers and customers interact within one or multiple tiers. The current solution facilitates interaction between producer segments, or sellers, and consumers, or buyers.

### BACKGROUND

Construction contractors encounter myriad known and unknown challenges in the course of their work, including the pursuit of new business, logistics, timelines, materials, human resources, the jobsite, unhappy customers, etc. The impact on the contractor includes loss of profit, delays, stress and the potential for customers to leave negative reviews on high-profile websites. Contractors are frustrated with deficient, expensive lead generation platforms. And, they must rely on homeowners to produce critical information when it comes to the history of the home. Currently, there are no good resources available to contractors and there are no products available to tie together all the different agents involved with a house, or home, including for example, homeowners, contractors, service professionals, appraisers, banks and insurers. In addition, homeowners have no digital solution to efficiently track and connect contractors and home services professionals that perform service on their home. Homeowners also lose track of warranties and maintenance paperwork. Real estate appraisers rely on homeowners for accurate records for things like roofs, furnace and windows. Banks experience bottlenecks and delays in approval and closing because of lack of information needed to establish the value of the property. Insurers miss opportunities to track critical information that helps. Therefore, improvements are desirable.

### SUMMARY

This invention relates to a system and method for a multi-sided platform that serves as an intermediary to connect two or more mutually supporting user groups, where multiple suppliers and customers interact within one or multiple tiers. The current solution facilitates interaction between producer segments and consumers. The central theme is to connect buyers and sellers.

In a first aspect of the present invention, a processor-based method of facilitating interaction and records regarding a home is disclosed. The method includes initiating a home profile; prompting a contractor to provide contractor data regarding the home; receiving the contractor data; populating the home profile with the contractor data; inviting an owner of the home to accept the home profile; if the owner accepts the home profile, prompting the owner to provide owner data regarding the home; receiving the owner data; populating the home profile with the owner data; and connecting the contractor and the owner together to interact and engage through the home profile. As such, accurate historical records regarding the home are maintained and interaction between the contractor and owner provides updating of the home profile, maintenance of the home and lead generation.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is a block diagram of an exemplary system tying together various parties involved around a home, according to one example embodiment.

FIG. 2 is block diagram of a platform using a home profile, according to one example embodiment.

FIG. 3 is an example data input screen, according to one example embodiment.

FIG. 4 is an example data input screen, according to one example embodiment.

FIG. 5 is an example data input screen, according to one example embodiment.

FIG. 6 is an example data input screen, according to one example embodiment.

FIG. 7 is an example data input screen, according to one example embodiment.

FIG. 8 is an example data input screen, according to one example embodiment.

FIG. 9 is an example data input screen, according to one example embodiment.

FIG. 10 is an example data input screen, according to one example embodiment.

FIG. 11 is an example data input screen, according to one example embodiment.

FIG. 12 is an example data input screen, according to one example embodiment.

FIG. 13 is an example data input screen, according to one example embodiment.

FIG. 14 is an example data input screen, according to one example embodiment.

FIG. 15 is an example data input screen, according to one example embodiment.

FIG. 16 is an example data input screen, according to one example embodiment.

FIG. 17 is an example data input screen, according to one example embodiment.

FIG. 18 is a flow diagram illustrating a method of facilitating interaction and records, according to one example embodiment.

FIG. 19 is a block diagram of a first engagement scenario, according to one example embodiment.

FIG. 20 is a block diagram of a second engagement scenario, according to one example embodiment.

FIG. 21 is a block diagram of a third engagement scenario, according to one example embodiment.

FIG. 22 is a block diagram of a network, according to one example embodiment.

FIG. 23 is a block diagram of a computing device, according to one example embodiment.

### DETAILED DESCRIPTION

The following description provides exemplary embodiments of the current invention, which is a platform and method for building a profile to facilitate the interaction and record keeping surrounding a home. In the present disclosure, a multi-sided platform serves as an intermediary to connect two or more mutually supporting user groups, where multiple suppliers and customers interact within one or multiple tiers. The current solution facilitates interaction between producer segments (contractors, home services professionals and other B2C professionals) and consumers (homeowners). The central theme is to connect buyers and sellers.

The platform facilitates interactions between contractors and homeowners. The homeowner can create a virtual catalog of information about their home or residence that allows them to accurately forecast repairs and improvements. The homeowner can create and share a directory of home services professionals they have successfully utilized, making it easy for them to reengage or recommend to others. Comprehensive data about the home will facilitate the retention of value, record keeping, planning, budgeting and allow greater resale opportunities. The platform helps home service professionals by populating their project pipelines with qualified, high value leads supplied by the homeowners with comprehensive data about the home. In addition, during a project, a shared portal could be established between the homeowner and the contractor to facilitate communication about the project, schedule and costs.

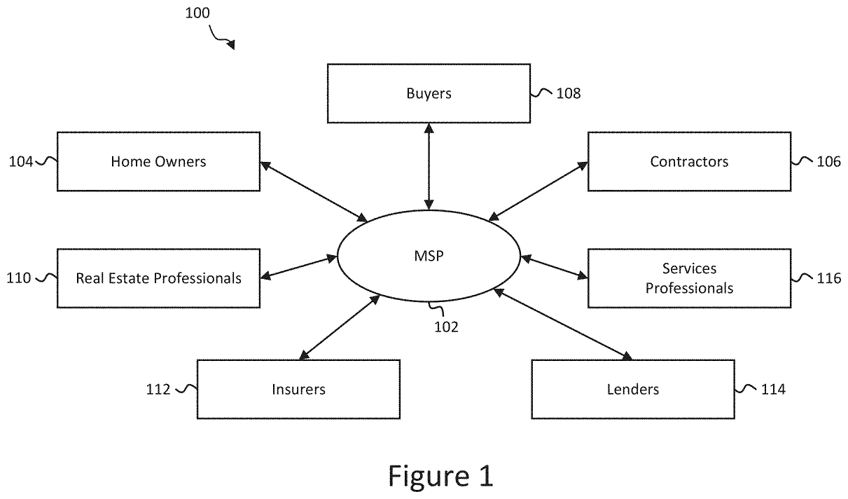

Referring now to FIG. 1, a block diagram of a platform 100 for facilitating interaction between different parties involved in a home is illustrated. Preferably, the platform 100 includes a multi-sided platform (MSP) 102 that interconnects all the parties involved. In this example embodiment, the parties include homeowners 104, contractors 106, potential buyers 108, real estate professionals 110, insurers 112, lenders 114 and service professionals 116. Not only can these parties communicate through the MSP, but information can also be shared. Such information can include warranty information, last service date, age of the device being repaired, etc.

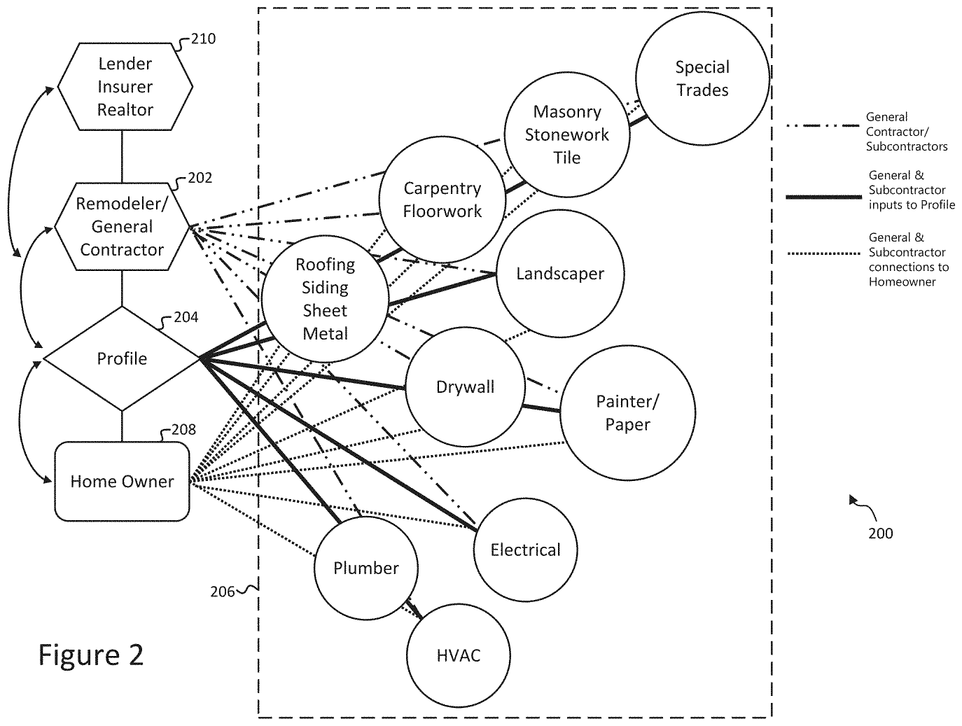

Referring to FIG. 2, a platform 200 illustrating the creation and populating of a profile in the MSP 102 is illustrated. Preferably, a contractor 202, such as a general contractor, initiates a profile 204 for a home and populates data about the home into the profile using the MSP 102. The contractor 202 can invite subcontractors 206 to participate in the profile-building. The subcontractors 206 include roofing, siding, plumber, HVAC, electrical, etc. The profile 204 can also include the construction materials, appliances, and fixtures. For example, the HVAC subcontractor may include its contact information, a list of equipment put in the house, serial numbers, warranties, brands, etc. The contractor 202 then engages a homeowner 208 to accept the profile 204 and the homeowner 208 takes possession of the profile 204.

The homeowner 208 then continues engagement with the profile 204 and adds additional inputs to the profile 204. The home profile 204 can include purchases, serial numbers, composition of materials and manufacturers, warranties, contact information for service providers, insurance needs, maintenance records, etc. The home profile 204 can include the home address, legal description, blueprint, dimensions, construction materials, design elements, etc. In addition, the homeowner 208 may have service done to the furnace and can upload the date, who performed the service, what service was performed and review the service professional. Lenders, insurers, and realtors 210 can also have access and provide input into the profile 204. For example, an insurer could input the insured value, yearly premium and risk rating. The lender could provide mortgage information, and the realtor could provide an updated market appraisal.

The contractor 202 or subcontractor 206 can use the MSP 102, to apprise the homeowner 208 of maintenance needs or volunteer to inspect the home after a storm. The contractor 202 could interact with the insurance company 210 regarding storm damage. The homeowner 208 could initiate such interaction by posting that the home had been damaged by a storm. As such, the system 102 creates lasting connections between the contractor 202, subcontractors 206 and the home owner 208. The contractors 202, 206 will gain brand recognition by regular participation and create future projects. The contractor 202 can connect to manufacturers and retailers for warranties and recalls and align and engage with subcontractors 206. Data, such as costs and schedule can be shared among the participants within the system 102 as well.

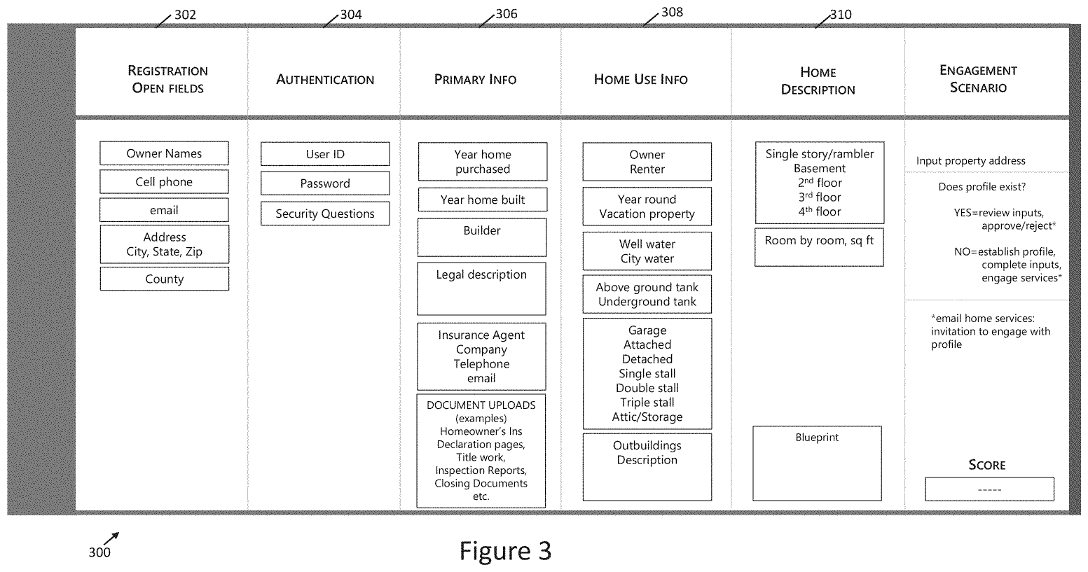

Referring to FIG. 3, an example user interface 300 for inputting basic information about the home is illustrated. The user interface 300 includes registration fields 302, authentication fields 304, primary information 306 about the home, home use information 308 and a home description 310. The primary information 306 includes the owners' names, cell phone, email, address and country. The authentication fields 304 include a user ID, password and security questions. The primary information 306 includes the year of purchase, year built, builder, legal description, insurance company and document uploads. The home user information 308 includes whether the home is rented, lived in year round, city or well water, etc. The home description fields 310 includes the size of the home, stories, style and blueprint.

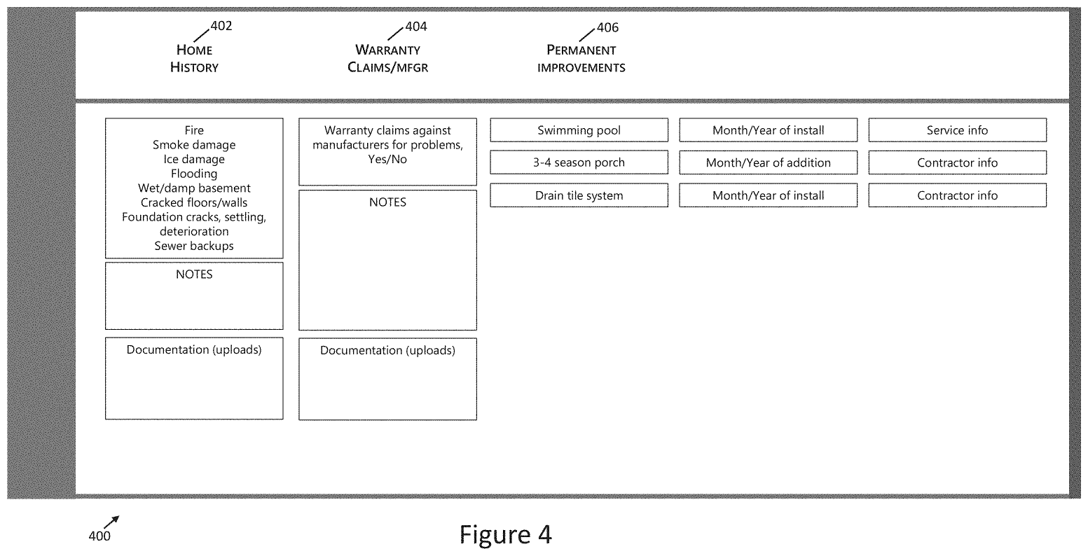

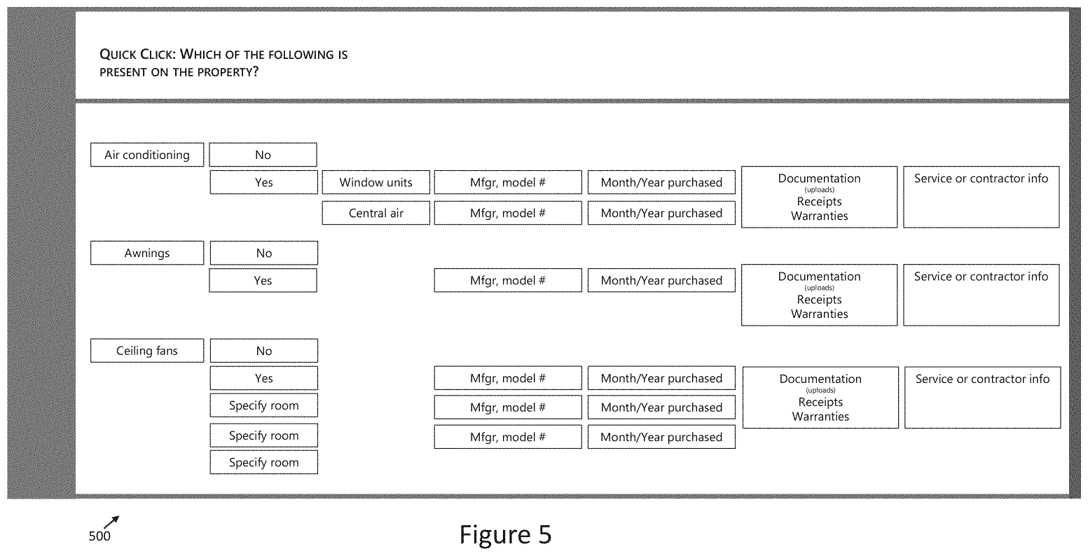

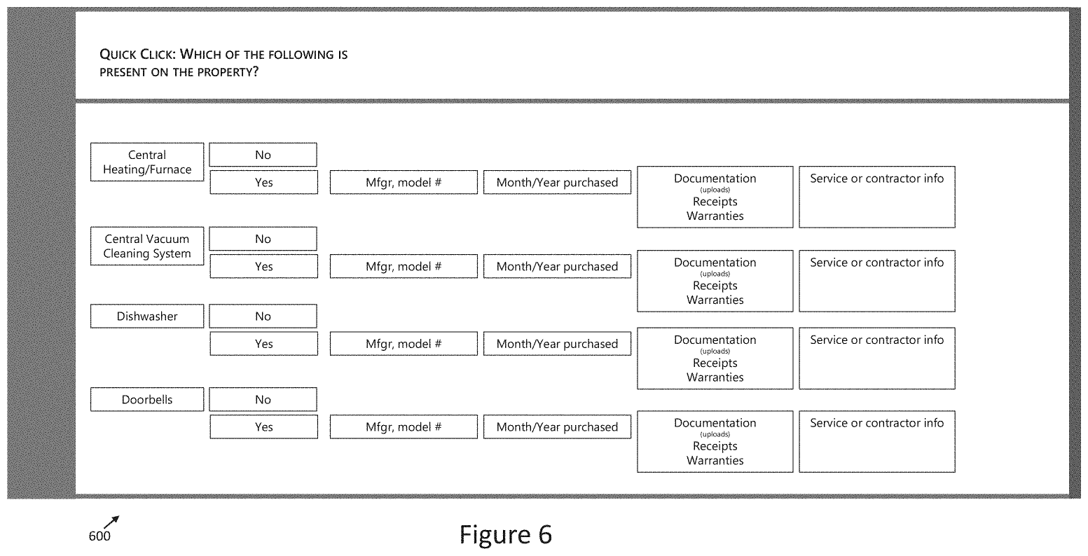

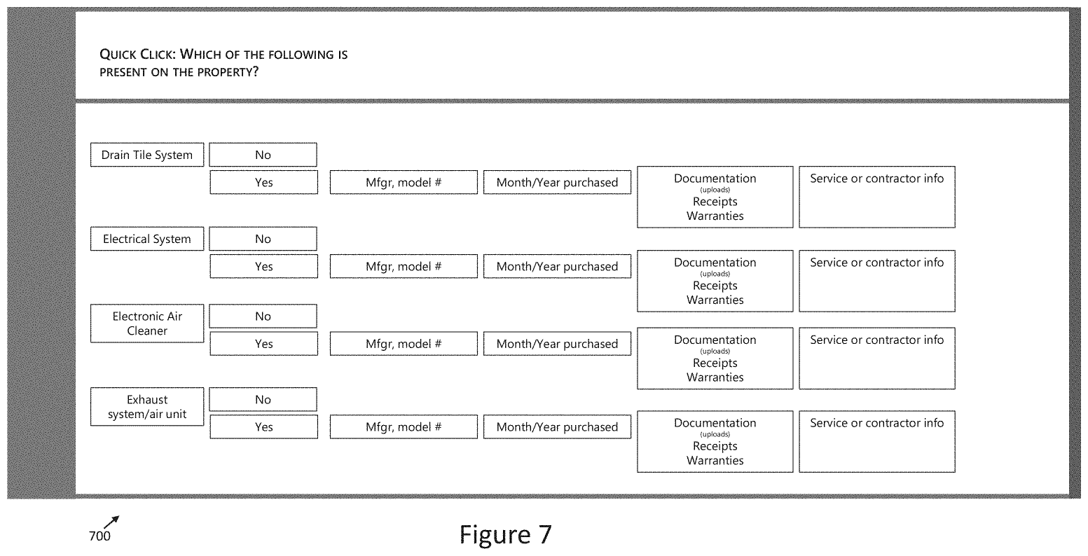

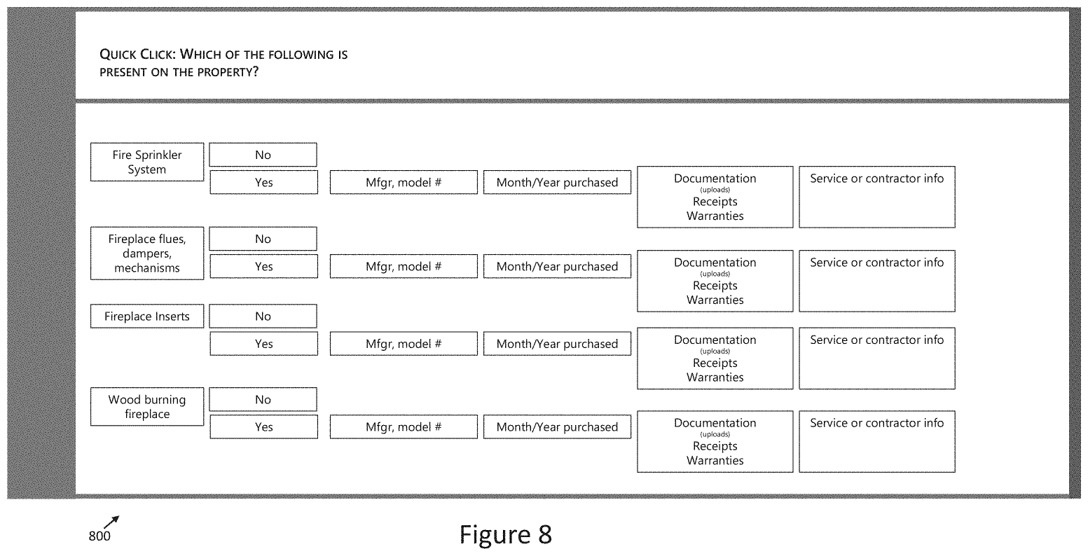

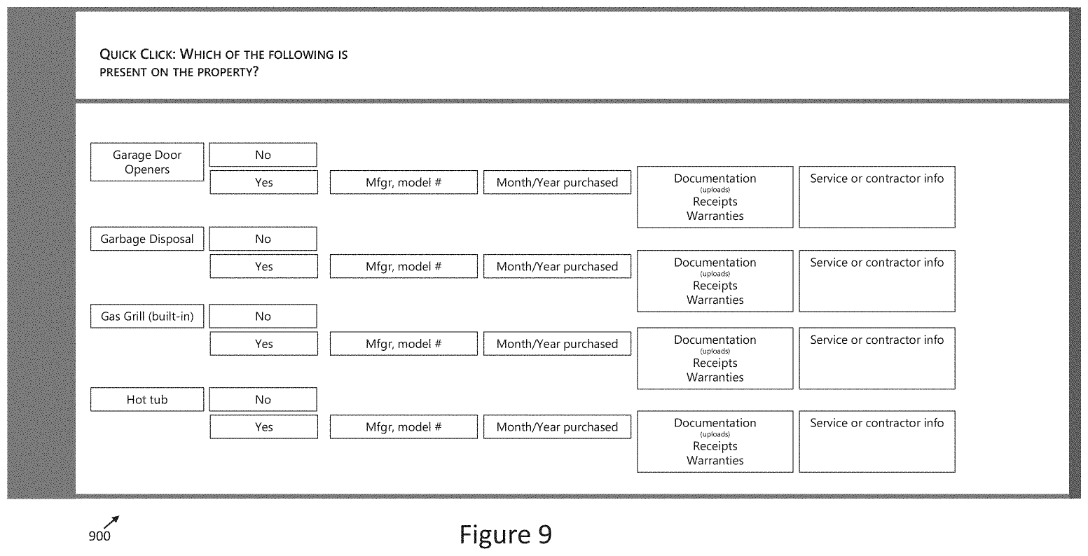

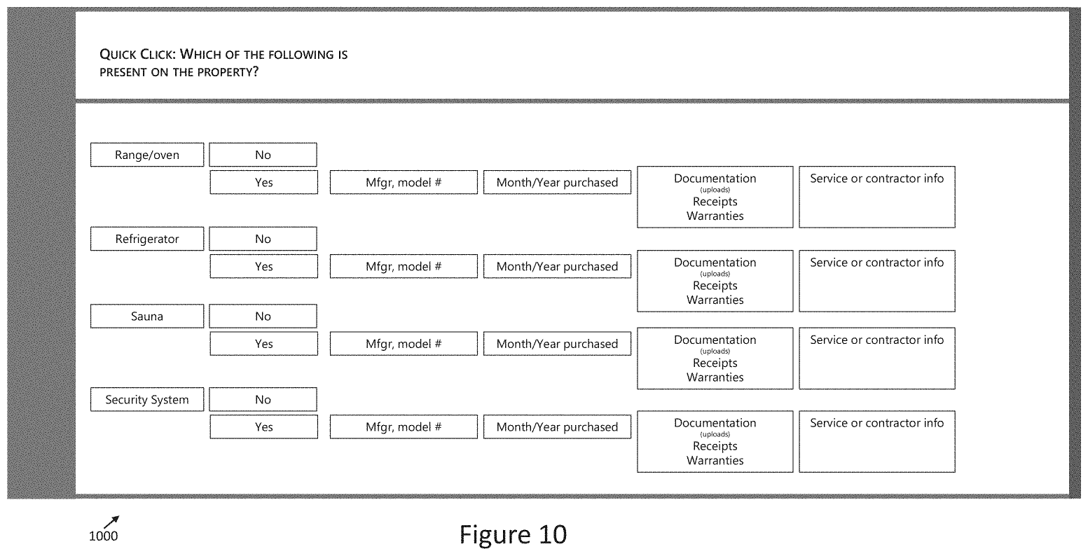

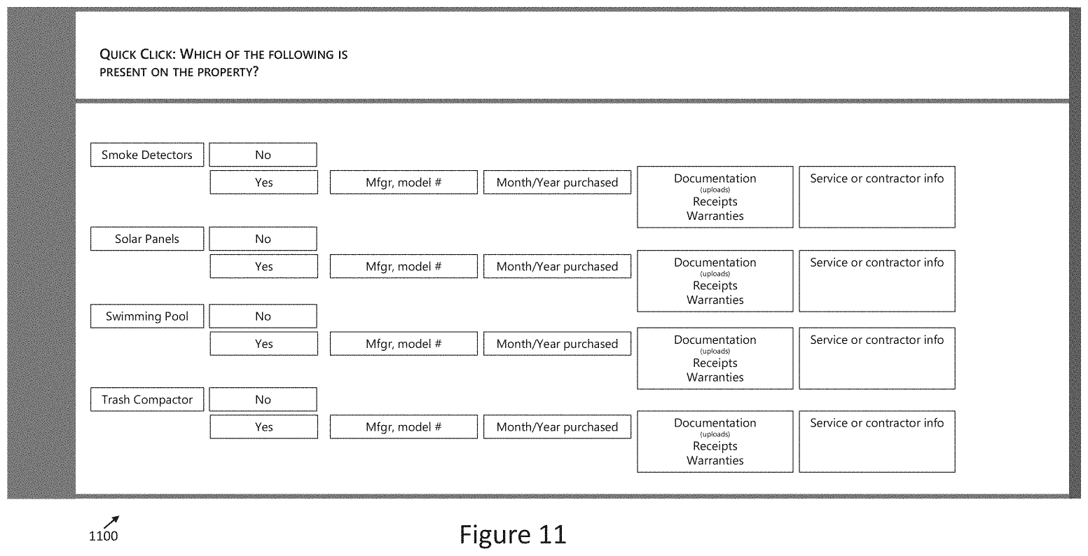

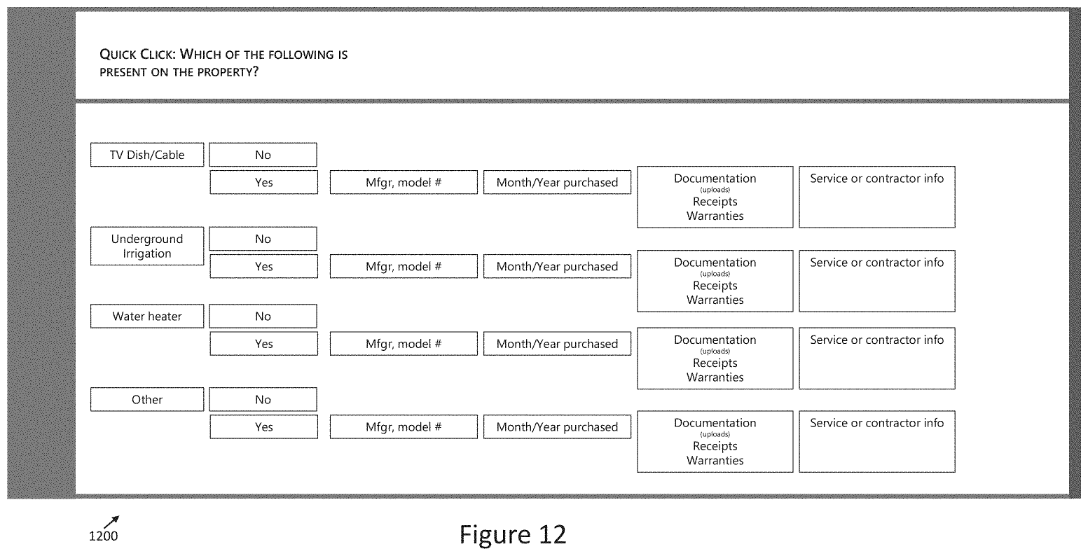

Referring to FIG. 4, an example user interface 400 for additional information is illustrated. Additional fields include a home history 402, warranties or claims 404 and permanent improvements 406. Referring to FIGS. 5-12 illustrate additional fields 500-1200, respectively, that can be included in a profile, for example the profile 204 of FIG. 2.

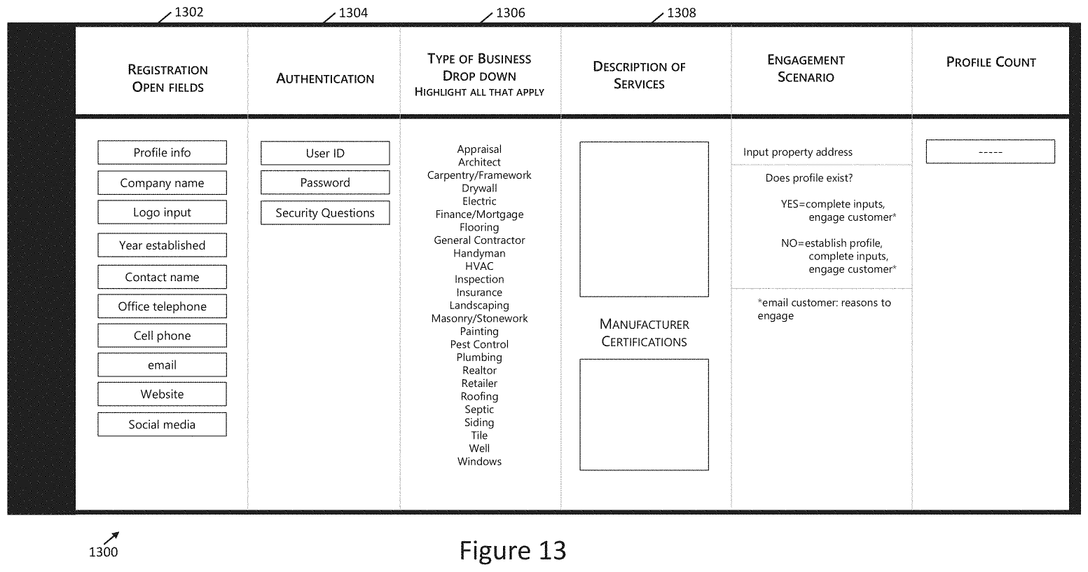

Referring to FIG. 13, an example user interface 1300 for a contractor is illustrated. The user interface 1300 includes registration open fields 1302, authentication 1304, type of business 1306, a description of services 1308 and manufacturer certifications 1310. The open fields 1302 can include profile information, company name, logo input, year established, contact name, office telephone, cell phone, email, website and social media information. The authentication 1304 includes a user ID, password and security questions. The type of business 1306 includes a listing of types of business eligible for selection. The description of services 1308 can be billed by the contractor. The manufacturer certifications 1310 an also be filled in by the contractor.

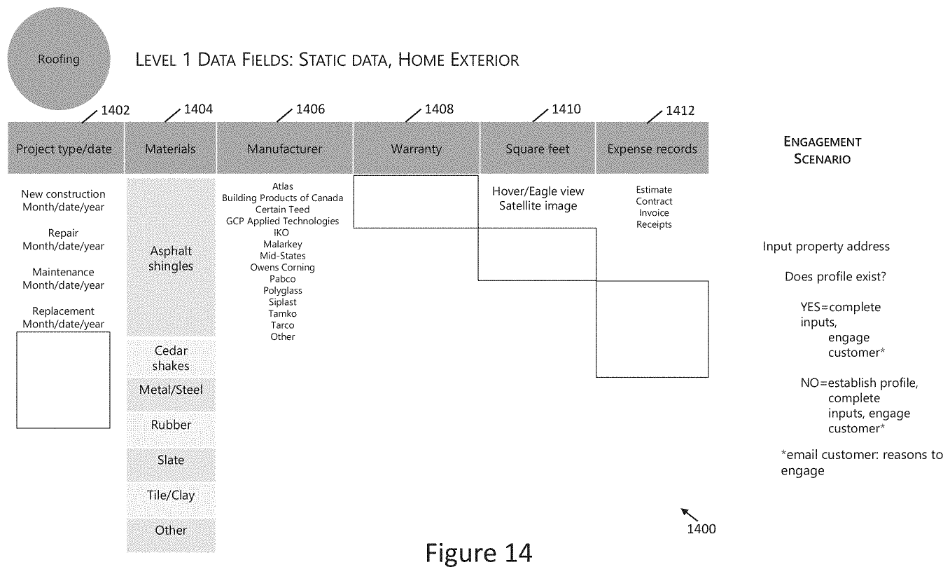

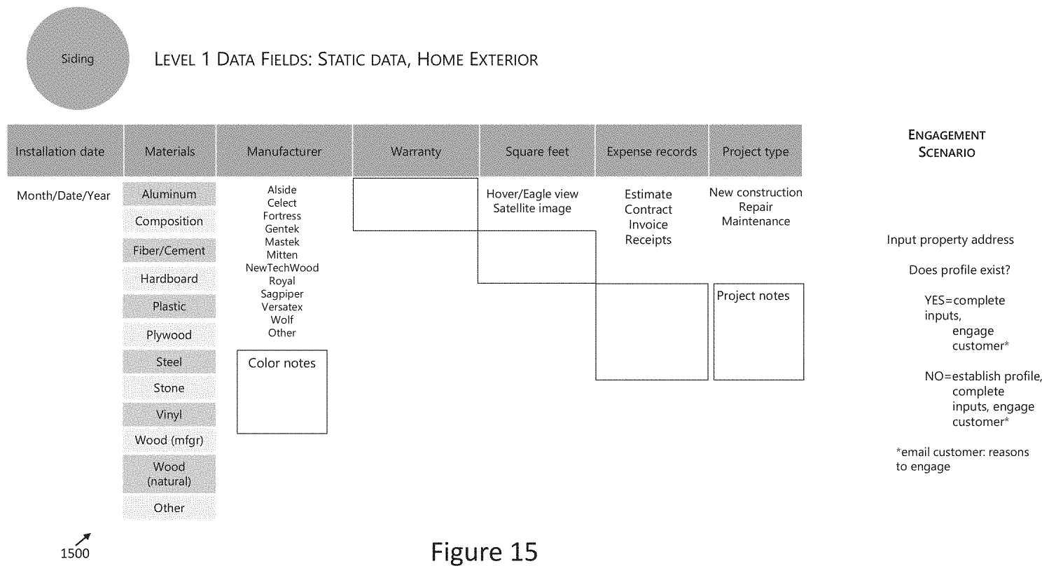

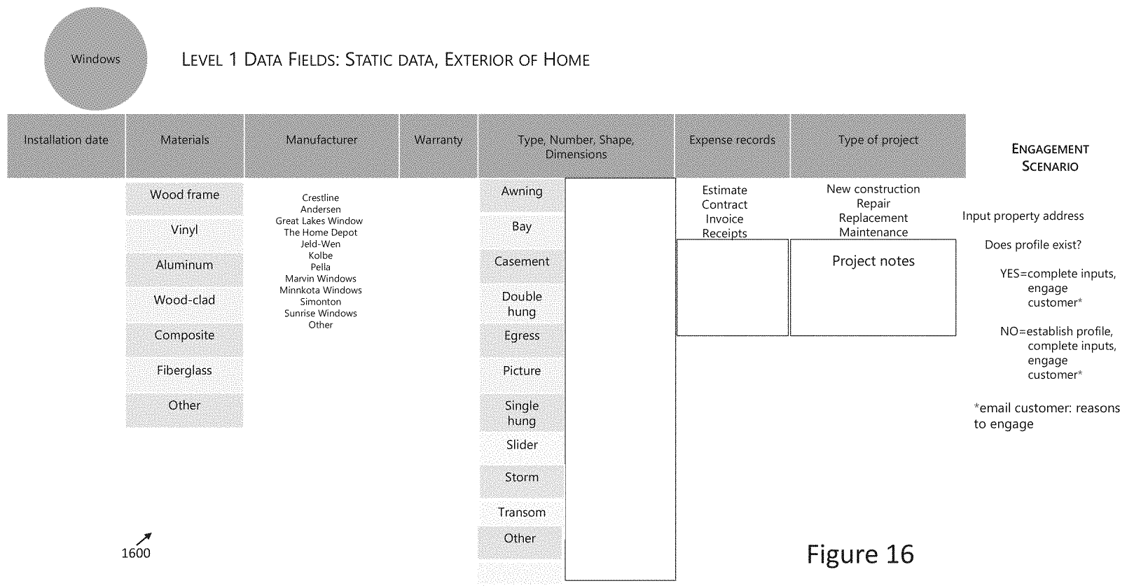

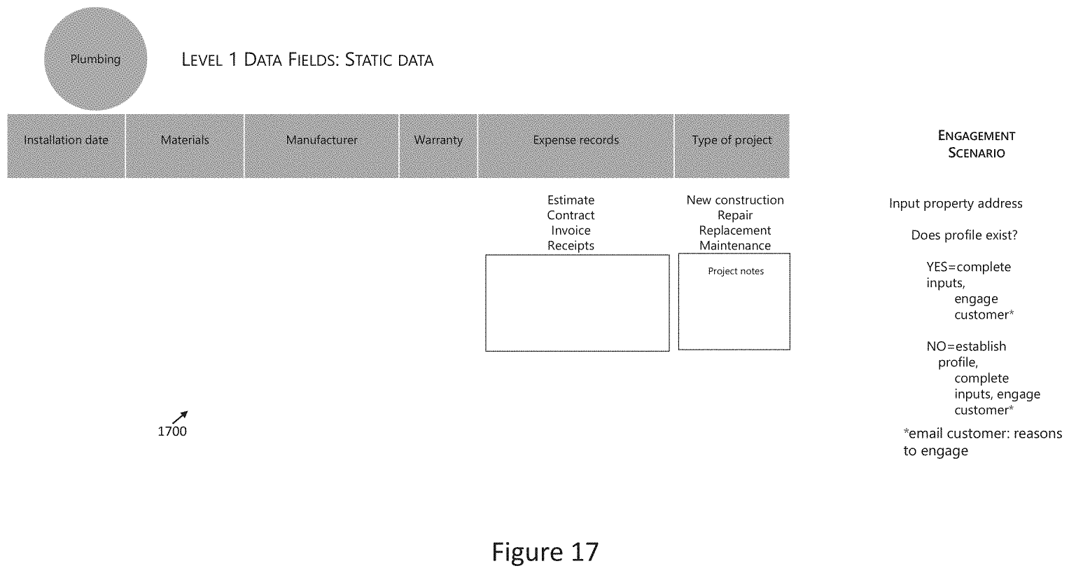

Referring to FIG. 14, an example user interface 1400 for inputting additional data related to the home, in particular related to the roof, is illustrated. The additional data includes the project type 1402, materials 1404, manufacture 1406, warranty 1408, size of the home 1410 and expense records 1412. Likewise, FIG. 15 is an example user interface 1500 for inputting additional data related to the home for siding; FIG. 16 is an example user interface 1600 for inputting additional data related to the home for windows; and FIG. 17 is an example user interface 1700 for inputting additional data related to the home for plumbing.

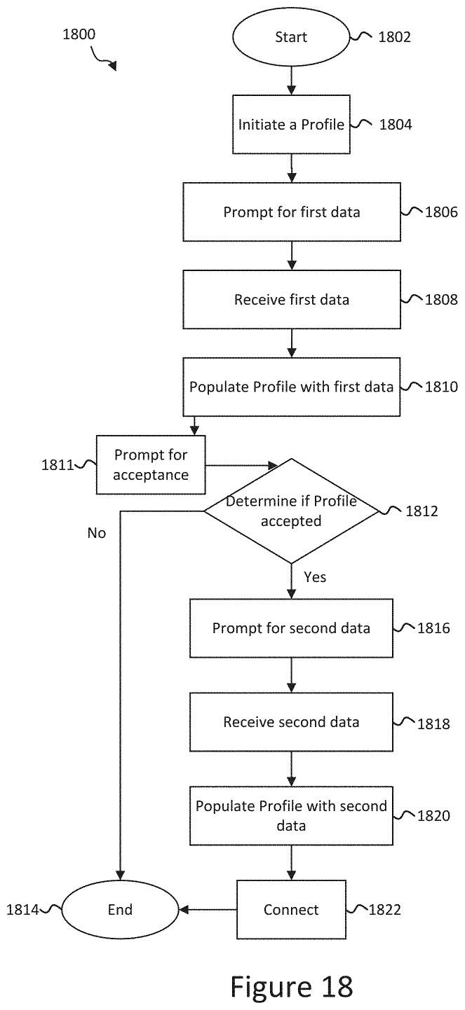

Referring to FIG. 18, a flow diagram illustrating a method 1800 of facilitating interaction and record keeping regarding a product, such as a home, is illustrated. Flow begins at 1802. At 1804, a profile, such as a home profile 204 of FIG. 2, is initiated by a first party, such as the contractor 202 of FIG. 2. At 1806, the first party is prompted for first data for the profile. At 1808, the first data is received. At 1810, the profile is populated with the first data. At 1811, a second party, such as the homeowner 208 of the home, is prompted as to whether the second party wishes to accept the profile. At 1812, the method 1800 determines if the profile is accepted by the second party. If the second party does not accept the profile, flow branches “NO” and ends at 1814. At 1812, if the second party accepts the profile, then flow branches YES to 1816 and the method prompts for second data, for example the system prompts the homeowner 208 for owner data such as a cell phone number. At 1818, the second data is received. At 1820 the profile is populated with the second data. At 1822 the first party and the second party are connected through the profile and flow ends at 1814.

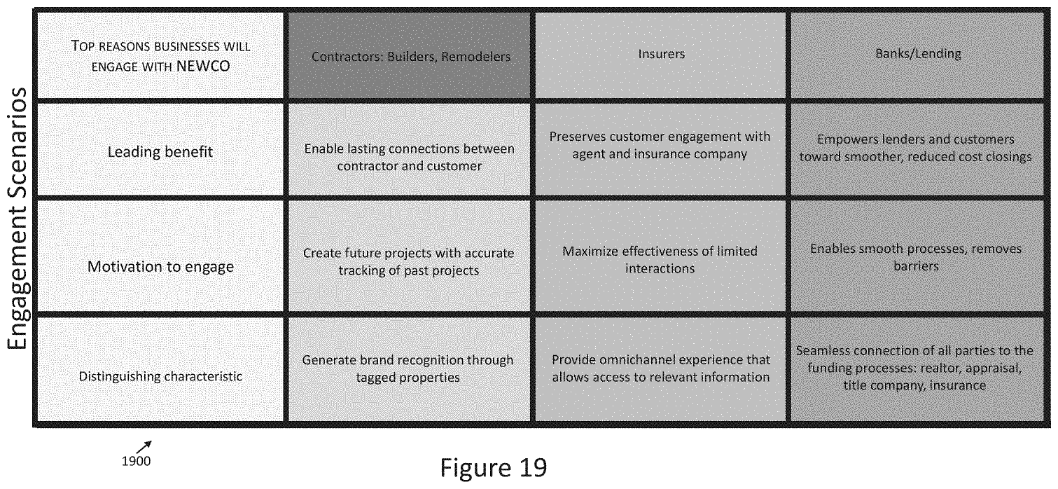

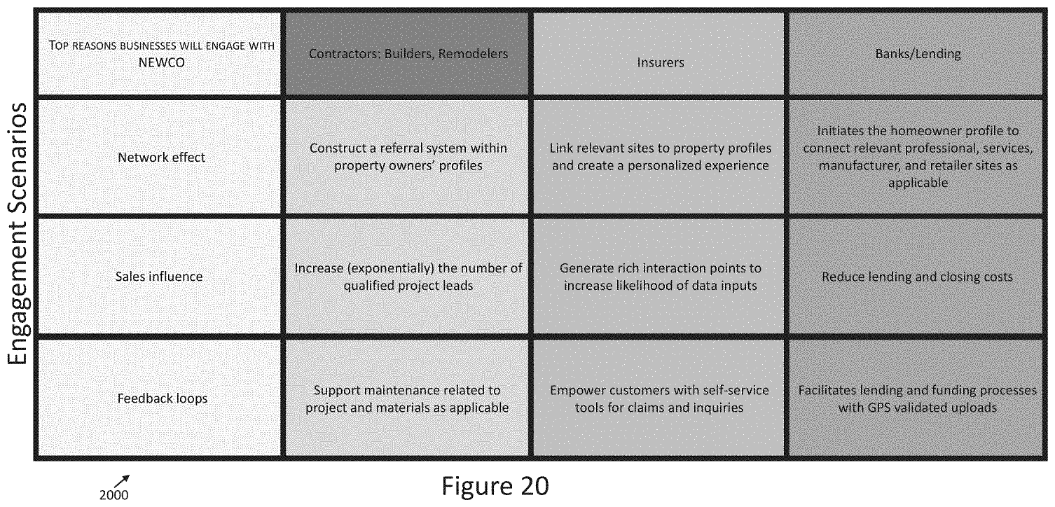

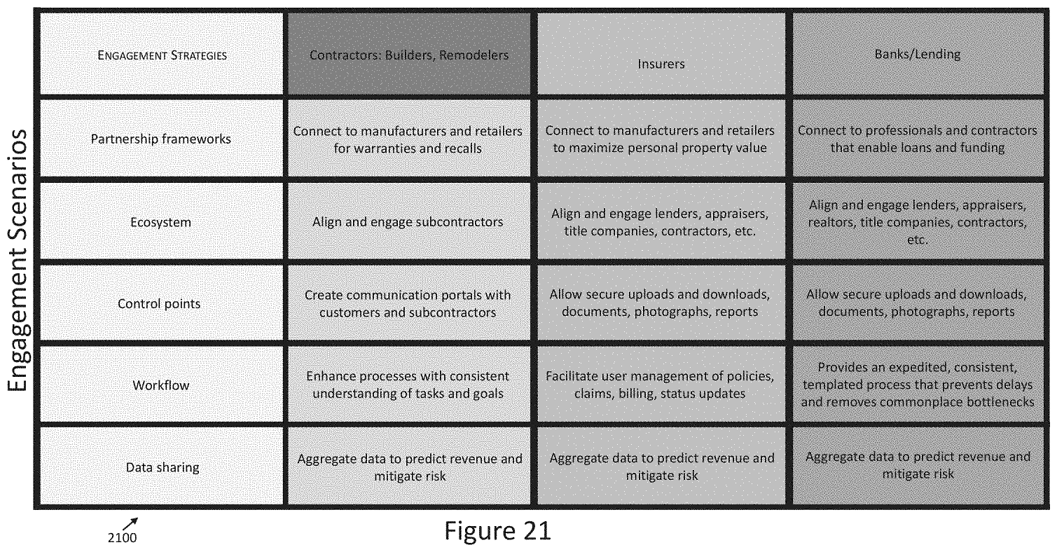

FIGS. 19, 20 and 21 illustrate example engagement scenarios 1900, 2000, 2100, respectively, according to example embodiments of the present invention.

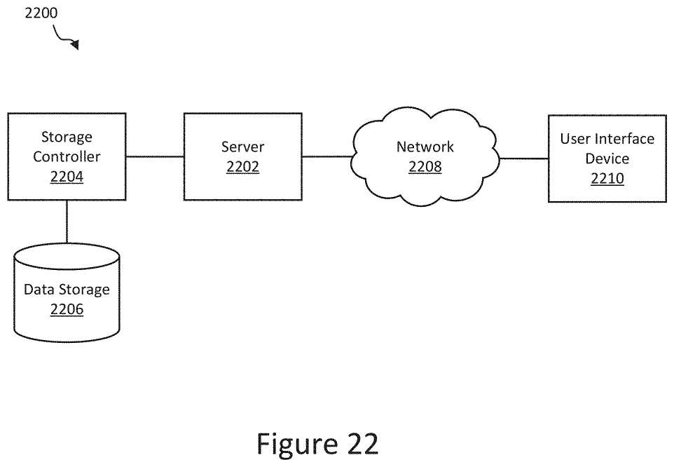

FIG. 22 illustrates one embodiment of a system 2200 for a system, which may host a multi-sided platform. The system 2200 may include a server 2202, a data storage device 2206, a network 2208, and a user interface device 2210. The server 2202 may be a dedicated server or one server in a cloud computing system. The server 2202 may also be a hypervisor-based system executing one or more guest partitions. The user interface device 2210 may be, for example, a mobile device operated by an administrator. In a further embodiment, the system 2200 may include a storage controller 2204, or storage server configured to manage data communications between the data storage device 2206 and the server 2202 or other components in communication with the network 2208. In an alternative embodiment, the storage controller 2204 may be coupled to the network 2208.

In one embodiment, the user interface device 2210 is referred to broadly and is intended to encompass a suitable processor-based device such as a desktop computer, a laptop computer, a personal digital assistant (PDA) or tablet computer, a smartphone or other a mobile communication device having access to the network 2208. The user interface device 2210 may be used to access a web service executing on the server 2202. When the device 2210 is a mobile device, sensors (not shown), such as a camera or accelerometer, may be embedded in the device 2210. When the device 2210 is a desktop computer the sensors may be embedded in an attachment (not shown) to the device 2210. In a further embodiment, the user interface device 2210 may access the Internet or other wide area or local area network to access a web application or web service hosted by the server 2202 and provide a user interface for enabling a user to enter or receive information.

The network 2208 may facilitate communications of data, such as dynamic license request messages, between the server 2202 and the user interface device 2210. The network 2208 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 2210 accesses the server 2202 through an intermediate sever (not shown). For example, in a cloud application the user interface device 2210 may access an application server. The application server may fulfill requests from the user interface device 2210 by accessing a database management system (DBMS). In this embodiment, the user interface device 2210 may be a computer or phone executing a Java application making requests to a JBOSS server executing on a Linux server, which fulfills the requests by accessing a relational database management system (RDMS) on a mainframe server.

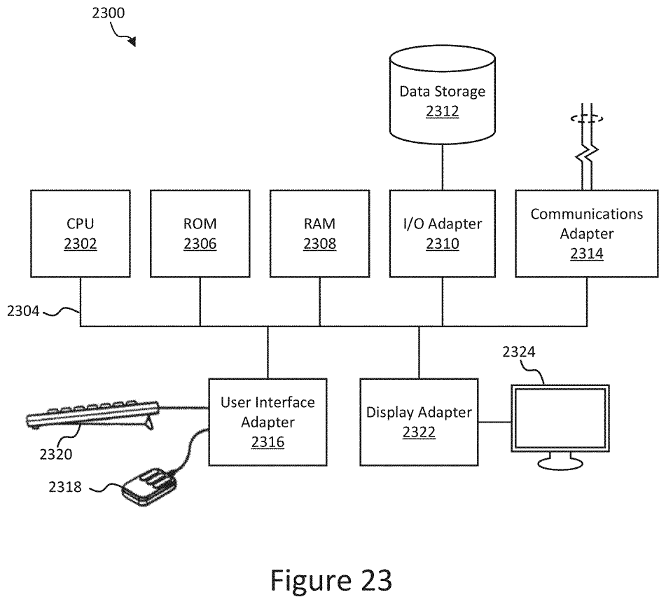

FIG. 23 illustrates a computer system 2300 adapted according to certain embodiments of the server 2202 and/or the user interface device 2210. The central processing unit (“CPU”) 2302 is coupled to the system bus 2304. The CPU 2302 may be a general purpose CPU or microprocessor, graphics processing unit (“GPU”), and/or microcontroller. The present embodiments are not restricted by the architecture of the CPU 2302 so long as the CPU 2302, whether directly or indirectly, supports the operations as described herein. The CPU 2302 may execute the various logical instructions according to the present embodiments.

The computer system 2300 also may include random access memory (RAM) 2308, which may be synchronous RAM (SRAM), dynamic RAM (DRAM), synchronous dynamic RAM (SDRAM), or the like. The computer system 2300 may utilize RAM 2308 to store the various data structures used by a software application. The computer system 2300 may also include read only memory (ROM) 2306 which may be PROM, EPROM, EEPROM, optical storage, or the like. The ROM may store configuration information for booting the computer system 2300. The RAM 2308 and the ROM 2306 hold user and system data, and both the RAM 2308 and the ROM 2306 may be randomly accessed.

The computer system 2300 may also include an input/output (I/O) adapter 2310, a communications adapter 2314, a user interface adapter 2316, and a display adapter 2322. The I/O adapter 2310 and/or the user interface adapter 2316 may, in certain embodiments, enable a user to interact with the computer system 2300. In a further embodiment, the display adapter 2322 may display a graphical user interface (GUI) associated with a software or web-based application on a display device 2324, such as a monitor or touch screen.

The I/O adapter 2310 may couple one or more storage devices 2312, such as one or more of a hard drive, a solid state storage device, a flash drive, a compact disc (CD) drive, a floppy disk drive, and a tape drive, to the computer system 2300. According to one embodiment, the data storage 2312 may be a separate server coupled to the computer system 2300 through a network connection to the I/O adapter 2310. The communications adapter 2314 may be adapted to couple the computer system 2300 to the network 2208, which may be one or more of a LAN, WAN, and/or the Internet. The communications adapter 2314 may also be adapted to couple the computer system 2300 to other networks such as a global positioning system (GPS) or a Bluetooth network. The user interface adapter 2316 couples user input devices, such as a keyboard 2320, a pointing device 2318, and/or a touch screen (not shown) to the computer system 2300. The keyboard 2320 may be an on-screen keyboard displayed on a touch panel. Additional devices (not shown) such as a camera, microphone, video camera, accelerometer, compass, and or gyroscope may be coupled to the user interface adapter 2316. The display adapter 2322 may be driven by the CPU 2302 to control the display on the display device 2324. Any of the devices 2302-2322 may be physical and/or logical.

The applications of the present disclosure are not limited to the architecture of computer system 2300. Rather the computer system 2300 is provided as an example of one type of computing device that may be adapted to perform the functions of a server 2202 and/or the user interface device 2210. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 2300 may be virtualized for access by multiple users and/or applications. The applications could also be performed in a serverless environment, such as the cloud.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. A serverless environment, such as the cloud, could also be used.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. A serverless environment, such as the cloud, could also be used.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of facilitating interaction and records regarding a home, the method comprising:
initiating a home profile;
prompting a contractor to provide contractor data regarding the home;
receiving the contractor data;
populating the home profile with the contractor data;
inviting an owner of the home to accept the home profile;
if the owner accepts the home profile, prompting the owner to provide owner data regarding the home;
receiving the owner data;
populating the home profile with the owner data; and
connecting the contractor and the owner together to interact and engage through the home profile;
wherein accurate historical records regarding the home are maintained and interaction between the contractor and owner provides updating of the home profile, maintenance of the home and lead generation.

2. The method of claim 1 further comprising receiving third data from a lender, insurer or realtor and populating the profile with the third data.

3. The method of claim 2 further comprising connecting the lender, insurer or realtor.

4. The method of claim 1 wherein the profile can be used for lead generation for the contractor.

5. The method of claim 1 wherein the profile includes home use information, a description of the home, home history, warranty claims and improvements to the home.

6. The method of claim 5, wherein the profile further includes a listing of property in the home along with model number, year purchased, warranty, documentation and subcontractor information.

7. The method of claim 1, wherein the profile can include manufacturer certifications of the contractor, schedule, expense records.

8. The method of claim 1 further comprising receiving fourth data from a subcontractor and populating the profile with the fourth data.

9. The method of claim 9 further comprising connecting the subcontractor.
